(19) United States
(12) Patent Application Publication
(10) Pub. No.: US 2025/0239198 A1
(43) Pub. Date: Jul. 24, 2025

(54) DISPLAY CONTROL DEVICE, DISPLAY CONTROL METHOD, IMAGE PROCESSING SYSTEM, AND STORAGE MEDIUM

(71) Applicant: CANON KABUSHIKI KAISHA, Tokyo (JP)

(72) Inventor: HAJIME KAJITA, Kanagawa (JP)

(21) Appl. No.: 18/975,676

(22) Filed: Dec. 10, 2024

(30) Foreign Application Priority Data
Jan. 18, 2024 (JP) 2024-006153

(51) Int. Cl. G09G 3/20; G06T 7/11; G06T 7/90

(52) U.S. Cl. CPC G09G 3/2003; G06T 7/11; G06T 7/90; G06T 2207/10024; G09G 2320/0666; G09G 2320/0686

(57) ABSTRACT

In a display device 100, image data having image regions corresponding to an external display device on which an image is displayed and to a subject different from the external display device is acquired. A detection unit 104 detects a first region corresponding to an image display region of the external display device from the image data. A parameter generation unit 103 generates color adjustment parameters for color matching between the detected first region and a second region corresponding to the subject. A color conversion unit 105 applies color conversion using the generated color adjustment parameters to the first region to perform color adjustment.

### BACKGROUND OF THE INVENTION

### Field of the Invention

The present invention relates to a display control device, a display control method, an image processing system, a storage medium, and the like.

### Description of the Related Art

In-camera VFX is a technique of disposing and filming a real subject in front of an external display device. In virtual production, a production environment in which a background image displayed by an external display device and a real subject are simultaneously filmed and combined with a camera can be realized.

An example of an external display device is an LED wall in which light emitting diodes (LEDs) are disposed in a grid pattern. An image captured by a camera has a first region derived from the external display device and a second region derived from a real subject.

For example, it can be assumed that a performer and an art set are disposed between the external display device and the camera. The external display device displays a background image, and the camera films the external display device, the performer, and the art set together.

The first region is an image region derived from the external display device that displays the background image, and will be hereinafter referred to as an “external display device region.” The second region is an image region derived from the performer and the art set, and will be hereinafter referred to as a “natural image region.”

In a filming process, for color matching between the natural image region and the external display device region, adjustment of lighting and color adjustment of the external display device are performed. For color adjustment of the natural image region, by setting the white balance setting of the camera to match the lighting, colors can be captured which are close to those seen by the human eye.

However, if an LED wall is used as the external display device, LEDs used in the LED wall have steep spectral characteristics, and colors of the external display device region are greatly different from the colors seen by the human eye as compared to the natural image region.

The reason for this is that, as a light source has the steeper spectral characteristics, colors are more likely to be influenced by a difference between the standard spectral luminous efficiency (characteristics of the human eye) and spectral sensitivity characteristics of the camera. The influence is ultimately manifested as a difference in color.

In addition, since respective cameras have subtle differences in spectral sensitivity characteristics, colors are different for each camera. Thus, in order to make colors of the external display device region the same as the colors seen by the human eye, it is required to perform color adjustment on the external display device region.

Color adjustment methods for images include a method of using a color decision list (CDL) or a look up table (LUT). The content of color adjustment performed at a filming side can be quantified and recorded as data, and the color adjustment can be easily reproduced on the basis of the recorded data in a filming process, editing process, or the like carried out later.

Japanese patent No. 6335498 discloses a technique of allowing color adjustment processing performed in a previous process to be easily and accurately reproduced in a later process, with the aim of improving accuracy of color adjustment in CDL. In an extended meta information region of a CDL file, image quality adjustment parameters and region of interest information are recorded for each region of interest.

However, in color adjustment methods using CDL or LUT in the related art, a filming target in which an external display device and a real subject are mixed is not considered, and thus performing color adjustment only on an external display device region is not possible.

### SUMMARY OF THE INVENTION

A display control device of an embodiment of the present invention includes: an acquisition unit configured to acquire image data having a first region corresponding to a region in which an external display device displays an image and a second region corresponding to a subject different from the external display device; a detection unit configured to perform detection of the first region from the image data; a generation unit configured to generate a first parameter for performing color matching between the first region and the second region; and a color conversion unit configured to perform color adjustment of an image using the first parameter, wherein the color conversion unit performs the color adjustment on the first region detected by the detection unit using the first parameter.

Further features of the present invention will become apparent from the following description of embodiments with reference to the attached drawings.

### BRIEF DESCRIPTION OF THE DRAWINGS

FIG. 1 is a block diagram showing a configuration example of a display device according to a first embodiment.

FIG. 2 is a diagram showing an arrangement example of devices in generating color adjustment parameters according to the first embodiment.

FIG. 3 is a flowchart of generation processing of the color adjustment parameters according to the first embodiment.

FIG. 4 is a diagram showing a system configuration example when color matching is performed and an image is displayed on the display device.

FIG. 5 is a diagram illustrating determination of regions in color adjustment according to the first embodiment.

FIG. 6 is a flowchart of color adjustment processing according to the first embodiment.

FIGS. 7A and 7B are diagrams showing an example of color change before and after the color adjustment processing according to the first embodiment.

FIG. 8 is a block diagram showing a configuration example of a display device according to a second embodiment.

FIG. 9 is a flowchart of generation processing of color adjustment parameters according to the second embodiment.

FIG. 10 is a flowchart of color adjustment processing according to the second embodiment.

FIGS. 11A and 11B are diagrams showing an example of color change before and after color adjustment processing according to a third embodiment.

FIG. 12 is a block diagram showing a configuration example of a display device according to a fourth embodiment.

FIGS. 13A and 13B are explanatory diagrams of color adjustment files generated by the display device according to the fourth embodiment.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

However, a display control device according to the present invention may be applied as a device (such as a personal computer) separate from the display device. An image processing system in which, in an image that is obtained by in-camera VFX or the like and that includes an image region corresponding to an external display device and an image region of a natural image, in order to perform color matching between an external display device region and a natural image region, color conversion is applied to the external display device region will be described.

### First Embodiment

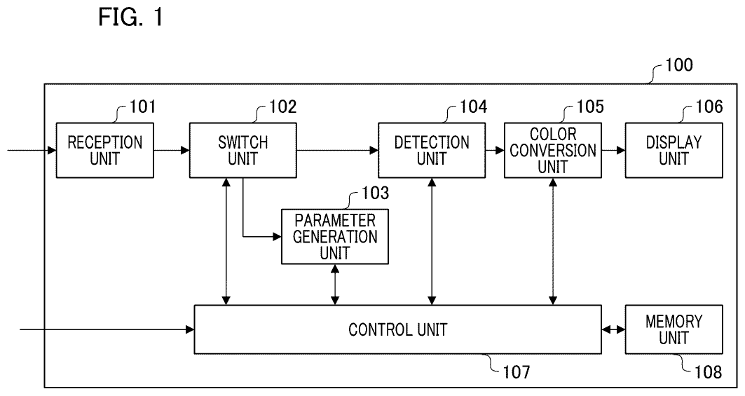

FIG. 1 is a block diagram showing a display device 100 as a configuration example of the display control device according to the present embodiment. The display device 100 includes a reception unit 101, a switch unit 102, a parameter generation unit 103, a detection unit 104, a color conversion unit 105, a display unit 106, a control unit 107, and a memory unit 108.

The reception unit 101 acquires video data from an external device such as an imaging device or a reproduction device and outputs the video data to the switch unit 102. For example, the reception unit 101 acquires frame data for each frame of a video from the external device and outputs the frame data to the switch unit 102.

The reception unit 101 can acquire the video data using a method that complies with a predetermined standard. The predetermined standard includes a standard such as serial digital interface (SDI) or high-definition multimedia interface (HDMI, registered trademark). The reception unit 101 can also acquire video data recorded in the memory unit 108.

The switch unit 102 is disposed as a part subsequent to the reception unit 101 and outputs the video data input from the reception unit 101 to either the parameter generation unit 103 or the detection unit 104. The display device 100 switches between generating color adjustment parameters from the video data or performing color conversion on the basis of a user's operation instruction.

The user's operation instruction can be performed by a signal output from an operation unit (not shown) to the control unit 107. The control unit 107 interprets the user's operation instruction and controls an output destination of the switch unit 102.

If the user's operation instruction is determined to be an instruction to generate the color adjustment parameters, the control unit 107 performs control of switching the output destination of the switch unit 102 to the parameter generation unit 103. Also, if the user's operation instruction is determined to be an instruction of the color conversion, the control unit 107 performs control of switching the output destination of the switch unit 102 to the detection unit 104.

The parameter generation unit 103 generates the color adjustment parameters for performing the color matching between the external display device region and the natural image region on the basis of the video data input from the switch unit 102. The color adjustment parameters are parameters for reducing differences between pixel values of a display image displayed on the external display device and pixel values of an image obtained by filming the display image with the imaging device.

The parameter generation unit 103 outputs the generated color adjustment parameters to the control unit 107 and performs processing of storing them in the memory unit 108 via the control unit 107.

The detection unit 104 detects the natural image region and the external display device region on the basis of metadata of the video data input from the switch unit 102 and outputs information of the detected regions (hereinafter referred to as “region information”) and the video data to the color conversion unit 105.

The metadata is, for example, ANC data standardized by SDI or data stored in the InfoFrame standardized by HDMI (registered trademark). The metadata indicates whether a target pixel is a pixel of the external display device region or a pixel of the natural image region, and is assumed to be assigned by an external device.

As for the region information, for example, on the basis of a distance map acquired by a ranging sensor, a region including pixels corresponding to the vicinity of a predetermined distance is set as the external display device region, and a region other than the external display device region is set as the natural image region.

The color conversion unit 105 performs the color conversion on the basis of the region information and the video data input from the detection unit 104. This color conversion is performed for the color matching between the external display device region and the natural image region.

The color adjustment parameters used at that time are generated by the parameter generation unit 103 and stored in the memory unit 108. The control unit 107 reads out the color adjustment parameters from the memory unit 108 and outputs them to the color conversion unit 105. The color conversion unit 105 outputs the processed video data to the display unit 106.

The display unit 106 displays an image based on the video data input from the color conversion unit 105 on a display screen. For example, the display unit 106 includes a liquid crystal display device having a liquid crystal display panel and a backlight unit, an organic electro luminescence (EL) display panel, or the like.

The control unit 107 controls each constituent unit of the display device 100. For example, the control unit 107 includes a central processing unit (CPU) and performs various types of control by reading out and executing programs stored in the memory unit 108. The memory unit 108 stores programs, parameters, video data, and the like. The control unit 107 controls writing and reading of information stored in the memory unit 108 and outputs the information to each constituent unit of the display device 100 when needed.

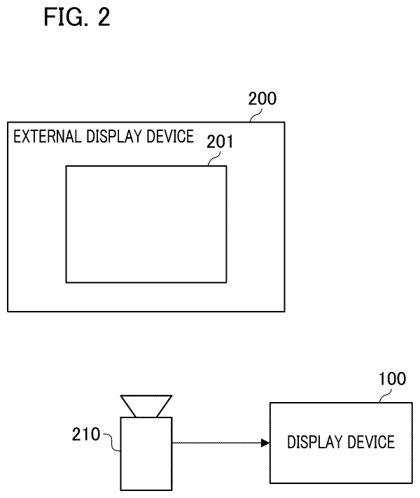

Next, a method for calculating the color adjustment parameters for the color matching between the external display device region and the natural image region will be described. FIG. 2 shows a schematic arrangement example of the display device 100, an external display device 200, and an imaging device 210 as a system configuration for generating the color adjustment parameters.

The video data when captured by the imaging device 210 facing the external display device 200 is input to the display device 100.

The external display device 200 displays a white patch 201. A region indicated by a rectangular frame on a screen of the external display device 200 is a region in which the white patch 201 is displayed. In display processing of the white patch 201, for example, pixel values (RGB values) in a bright region including a central portion of the screen are set to (255, 255, 255).

Also, pixel values in a dark region other than the bright region are set to (0, 0, 0). The imaging device 210 acquires an image in which the white patch 201 is displayed and outputs the imaged data to the display device 100.

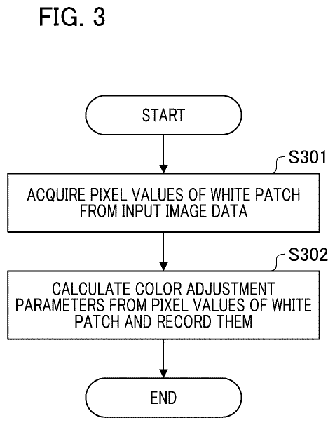

FIG. 3 is a flow chart showing an example of processing for generating the color adjustment parameters for the color matching between the external display device region and the natural image region. If the external display device 200 displays the white patch 201, the imaging device 210 captures an image and inputs image data to the display device 100, and then frame image data acquired by the reception unit 101 of the display device 100 is updated, processing of FIG. 3 starts.

In S301, the image data is input from the reception unit 101 to the parameter generation unit 103 via the switch unit 102. The parameter generation unit 103 acquires the pixel values of the white patch (patch measurement values) from the input image data.

A method for identifying the white patch region from the image data is, for example, a method of performing binarization processing of the image and determining the brighter of the two regions as the white patch region. Processing for calculating average values of pixel values in the white patch region (bright region) is performed, and the calculated average values are used as the pixel values of the white patch. The pixel values of the white patch are used in the next step S302.

In S302, the parameter generation unit 103 calculates the color adjustment parameters for the color matching between the external display device region and the natural image region from the patch measurement values in S301. The control unit 107 acquires the calculated color adjustment parameters from the parameter generation unit 103 and performs control of storing them in the memory unit 108.

Specifically, the pixel values of the white patch in the image data obtained by the filming are expressed as w_r, w_g, and w_b, and the minimum pixel value among them is expressed as w_min. The signs “_r,” “g,” and “_b” represent red, green, and blue components.

The parameter generation unit 103 calculates w_min/w_r, w_min/w_g, and w_min/w_b from the pixel values w_r, w_g, and w_b of the white patch and the minimum pixel value w_min. The color adjustment parameters for each color component are expressed as p_r, p_g, and p_b.

The calculated w_min/w_r, w_min/w_g, and w_min/w_b are stored in the memory unit 108 as p_r, p_g, and p_b. For example, if the patch measurement values are (230, 230, 255), the values of the color adjustment parameters are (1.0, 1.0, 0.9).

The color adjustment parameters stored in the memory unit 108 are read out from the memory unit 108 and used when the color conversion unit 105 executes color conversion processing. After the process of S302, the series of processes ends.

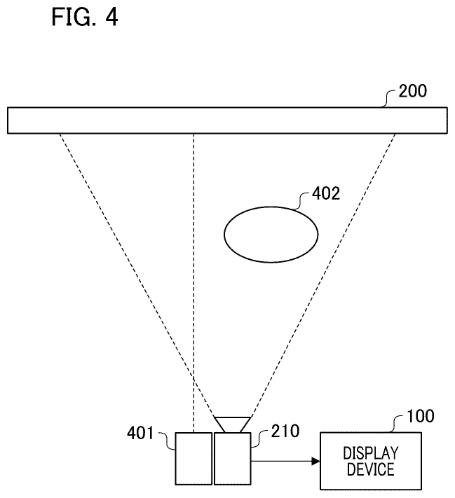

Next, a method for performing the color matching will be described with reference to FIG. 4. FIG. 4 shows a schematic arrangement example of the display device 100, the external display device 200, the imaging device 210, a ranging device 401, and a subject 402 as a system configuration when the color matching between the external display device region and the natural image region is performed to display the image on the display device.

The subject 402 is, for example, a person, and is located between the external display device 200 and the imaging device 210. The ranging device 401 has a ranging sensor, and the imaging device 210 and the ranging device 401 are disposed next to each other.

The metadata assigned to the captured image acquired by the imaging device 210 includes information indicating that pixels of the captured image are in the external display device region and information indicating that pixels of the captured image are in the natural image region.

The ranging device 401 measures distances of the external display device 200 and the subject 402. For example, before filming, the ranging device 401 measures a distance between the external display device 200 and the imaging device 210.

The ranging device 401 produces the distance map of the external display device 200 on the basis of the measured distance information. At the time of filming, the ranging device 401 measures a distance between the imaging device 210 and the subject 402. The ranging device 401 checks the already produced distance map of the external display device 200 and determines that a region with the same distance is the region of the external display device 200.

In a region in which a person who is the subject 402 is filmed, the distance between the subject 402 and the imaging device 210 is smaller than the distance between the external display device 200 and the imaging device 210. Thus, the ranging device 401 determines that a region in which the subject 402 is filmed is the natural image region.

In the example of FIG. 4, the captured image and the metadata assigned to the image have been described assuming that imaging device 210 and the ranging device 401 are separate devices, but the present invention is not limited thereto. The imaging device 210 may be configured to include a ranging device or a ranging function.

For example, using an imaging device provided with an imaging element using an imaging surface phase difference detection method, an amount of image deviation can be detected from phase difference detection signals output by each of a plurality of photoelectric conversion units in a pixel unit to acquire depth information (distance map, defocus map, and the like). Alternatively, a configuration in which stereo filming and ranging is possible can be used using a plurality of imaging devices.

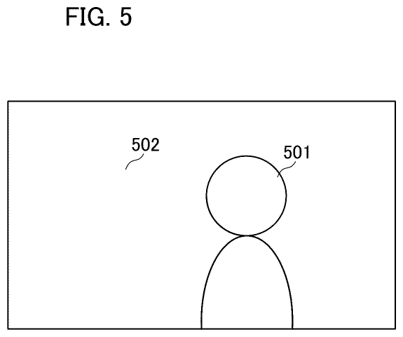

FIG. 5 is a schematic diagram illustrating which region of the external display device region or the natural image region a pixel in a moving image belongs to. A region 501 is an image region in which a person serving as a main subject is filmed and is the natural image region. A region 502 is the external display device region and is a region in which a background image is displayed at the time of filming.

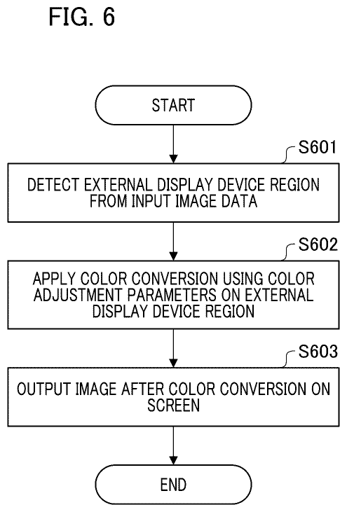

Processing executed by the display device 100 will be described with reference to FIG. 6. FIG. 6 is a flowchart showing an example of processing for displaying the image by performing the color matching between the external display device region and the natural image region. If the frame image data acquired by the reception unit 101 of the display device 100 is updated, the process of FIG. 6 starts.

In S601, the detection unit 104 acquires the video data and the metadata from the reception unit 101 via the switch unit 102. The detection unit 104 detects the external display device region and the natural image region on the basis of the region information included in the metadata, and outputs the video data and the region information to the color conversion unit 105. Then, the process proceeds to the processing of S602.

In S602, the color conversion unit 105 acquires the video data and the region information from the detection unit 104, and the color adjustment parameters read out from the memory unit 108. The color conversion unit 105 applies the color conversion to the external display device region using the color adjustment parameters on the basis of the region information and the color adjustment parameters.

The color conversion unit 105 outputs the video data after the color conversion is applied to the display unit 106. Here, pixel values before the color adjustment are expressed as (r_in, g_in, b_in), and pixel values after the color adjustment are expressed as (r_out, g_out, b_out).

The color conversion from the pixel values before the color adjustment (r_in, g_in, b_in) to the pixel values after the color adjustment (r_out, g_out, b_out) is expressed as the following equation (1) using the color adjustment parameters (p_r, p_g, p_b).

$$( \begin{matrix}{r}_{\_ out} \\ {g}_{\_ out} \\ {b}_{\_ out}\end{matrix} ) = \{ \begin{matrix}( \begin{matrix}{r}_{\_ in} \\ {g}_{\_ in} \\ {b}_{\_ in}\end{matrix} ) , in case of natural image region \\ ( \begin{matrix}{p}_{\_ r} \cdot {r}_{\_ in} \\ {p}_{\_ g} \cdot {g}_{\_ in} \\ {p}_{\_ b} \cdot {b}_{\_ in}\end{matrix} ) , in case of external display device region\end{matrix} \qquad ( 1 )$$

As can be seen from the equation (1), the color adjustment is not performed on the natural image region, and the color adjustment is performed on the external display device region on the basis of the color adjustment parameters. In the color conversion for the external display device region, processing for correcting a white balance deviation of the input pixel values and outputting them is performed.

By correcting the white balance deviation of the region whose image is obtained, using the imaging device, by capturing the image display region of the external display device, which has steep spectral characteristics, the color of the external display device region can be made closer to the color of the natural image region.

Next, the process proceeds to the processing of S603. In S603, the display unit 106 displays the image on the screen in accordance with the video data input from the color conversion unit 105. Then, the series of processes ends.

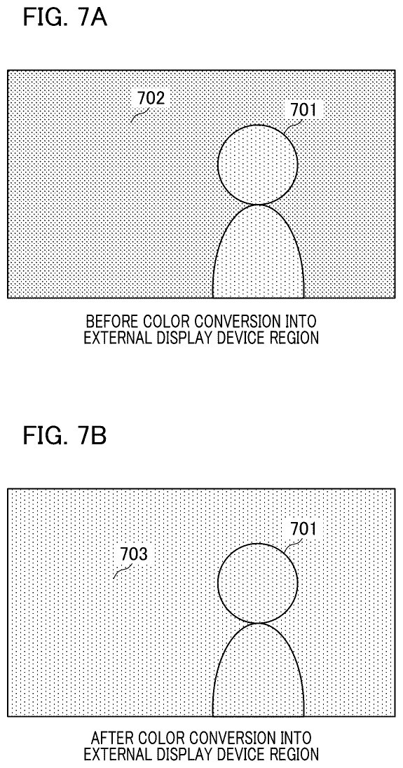

FIGS. 7A and 7B are diagrams schematically illustrating a difference between images before and after applying the color conversion to the external display device region. FIG. 7A shows an image before the color conversion, in which a natural image region 701 corresponds to a region in which a person serving as a main subject is filmed, and an external display device region 702 corresponds to a region in which a background image is filmed. FIG. 7B shows an image after the color conversion, in which the natural image region 701 is the same as that in FIG. 7A, but an external display device region 703 is different from that in FIG. 7A.

FIG. 7A shows that a deviation in white balance occurs between the natural image region 701 and the external display device region 702. FIG. 7B shows that, by performing the color adjustment on the external display device region 703, the white balance of the region 703 has come closer to that of the natural image region 701.

For example, pixel values of the region 701 are (255, 255, 255), and pixel values of the region 702 are (230, 230, 255). If (1.0, 1.0, 0.9) are applied as the color adjustment parameters, the pixel values of the region 703 after the color conversion become (230, 230, 230).

In this case, if the pixel values of the region 701 and the region 703 are normalized by dividing them by the maximum pixel value of each pixel, the pixel values of both regions become (1.0, 1.0, 1.0), and thus it can be seen that the white balance of the region 701 has come closer to that of the region 703.

In the present embodiment, the color conversion processing based on the color adjustment parameters is executed for the external display device region detected from the image data (video data), and the color matching is performed between the external display device region and the natural image region.

Color adjustment units in the related art have a problem that it is not possible to perform color adjustment only on an external display device region for a filming target in which a real subject corresponding to a natural image and an external display device are mixed.

In contrast, according to the present embodiment, it is possible to perform the color matching between the external display device region and the natural image region due to the color adjustment of the external display device region. Also, in the present embodiment, an example in which the pixel values (RGB values) of the white patch are used to adjust the white balance when the color adjustment parameters are calculated has been shown.

The present invention is not limited thereto, and instead of the pixel values of the white patch, the color adjustment parameters can be calculated on the basis of a brightness or a chromaticity, or a brightness and a chromaticity of the white patch.

As described above, according to the present embodiment, for an image having an image region corresponding to a region in which an external display device displays an image and an image region corresponding to a subject, a technology that enables color matching between both of the image regions can be provided.

### Second Embodiment

Next, a second embodiment will be described. A display device according to the present embodiment acquires data output by a plurality of imaging devices and identifies each imaging device using predetermined information.

For example, a case in which data is input from first and second imaging devices to the display device is assumed. The predetermined information is identification information such as manufacturers' names, model numbers, serial numbers, and the like of imaging devices, which are acquired from ANC data of SDI.

The display device performs color adjustment on an external display device region using individual color adjustment parameters for each imaging device on the basis of the identification information of the imaging devices. Detailed description of the same items and symbols in the present embodiment as those in the first embodiment will be omitted, and their differences will be mainly described. The same omission method of description will be applied to embodiments described later.

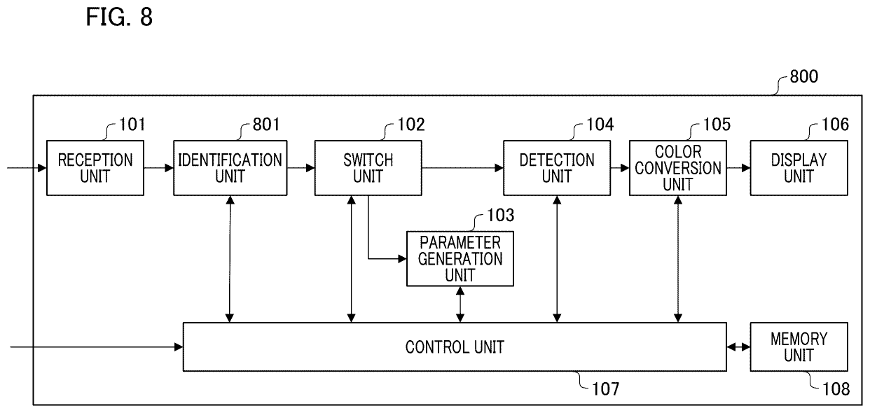

FIG. 8 is a block diagram showing a configuration example of a display device 800 according to the present embodiment. The difference of the display device 800 from the configuration shown in FIG. 1 is that an identification unit 801 is provided between the reception unit 101 and the switch unit 102.

The identification unit 801 is under the control of the control unit 107 and acquires video data and metadata thereof from the reception unit 101 to perform processing for identifying, using the metadata, from which imaging device they are input.

The control unit 107 performs control of distinguishing color adjustment parameters and storing them in the memory unit 108 together with data for managing of which imaging device the color adjustment parameters generated by the parameter generation unit 103 are.

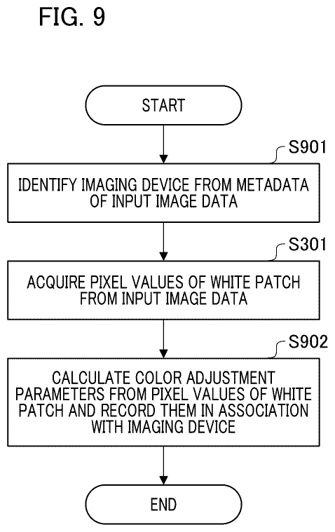

FIG. 9 is a flowchart showing a processing example relating to generation of the color adjustment parameters for performing color matching between the external display device region and the natural image region. In S901, the identification unit 801 acquires input image data from the reception unit 101 and identifies from which imaging device the input image data is input on the basis of metadata of the input image data. Then, the process proceeds to the processing of S301, and processing for acquiring the pixel values of the white patch from the input image data is executed.

In the next S902, the parameter generation unit 103 calculates the color adjustment parameters from the pixel values of the white patch. The memory unit 108 stores the color adjustment parameters together with information for associating the color adjustment parameters with the imaging device in order to use them for the color matching between the external display device region and the natural image region. Then, the series of processes ends.

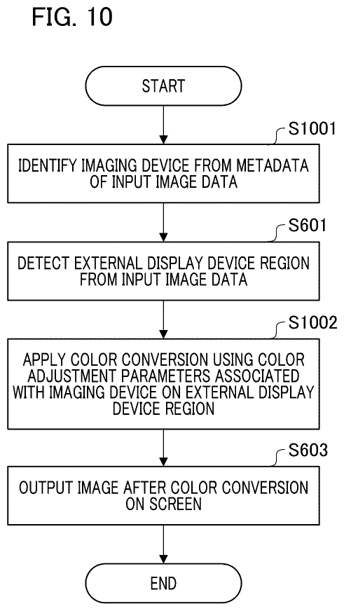

FIG. 10 is a flow chart showing a processing example for performing the color matching between the external display device region and the natural image region to display an image. Also, details of the processes of S601 and S603 already described in FIG. 6 will be omitted.

In S1001, the identification unit 801 acquires input image data from the reception unit 101 and identifies from which imaging device the input image data is input on the basis of metadata of the input image data. Next, after the processing of S601 is performed, the process proceeds to the processing of S1002.

In S1002, the color conversion unit 105 applies the color conversion using the video data and the region information input from the detection unit 104 and the color adjustment parameters associated with the imaging device stored in the memory unit 108.

The color conversion unit 105 outputs, to the display unit 106, the video data after the color conversion is applied to the external display device region using the color adjustment parameters associated with the imaging device. Next, the process proceeds to S603, and the image after the color conversion is output to the screen. Then, the series of processes ends.

In the present embodiment, the imaging device is identified by metadata of video signals, and the color matching is performed between the external display device region detected from the image and the natural image region on the basis of the color adjustment parameters associated with the imaging device.

It is possible to inhibit effects of subtle differences in sensitivity of the imaging sensors provided for each imaging device, and to perform the color adjustment only on the external display device region to perform the color matching with the natural image region.

### Third Embodiment

Next, a third embodiment will be described. In the present embodiment, a display control device can change a color tone of an appearance of the entire screen on the basis of color editing parameters such as CDL and LUT prepared by the user.

In this case, color conversions with different processing contents are respectively applied to the natural image region and the external display device region. In the present disclosure, “color editing” indicates color conversion using CDL, LUT, or the like prepared by the user, and “color adjustment” indicates color conversion using the color adjustment parameters calculated by the display control device from the patch measurement values.

Processing content of the color conversion unit 105 for the display control device differs from that of the above embodiment. The color conversion unit 105 performs color editing of the entire screen on the basis of the region information and the video data input from the detection unit 104, and performs the color adjustment on the external display device region.

Parameters used by the color conversion unit 105 for the color conversion are the color editing parameters specified by the user and the color adjustment parameters generated by the parameter generation unit 103. The color conversion unit 105 performs color conversion processing using different parameters for the external display device region and the natural image region and outputs the processed video data to the display unit 106.

Specifically, the color conversion unit 105 performs the color conversion represented by the following equation (2) and calculates the pixel values (r_out, g_out, b_out) after the color conversion from the pixel values (r_in, g_in, b_in) before the color conversion.

$$( \begin{matrix}{r}_{\_ out} \\ {g}_{\_ out} \\ {b}_{\_ out}\end{matrix} ) = \{ \begin{matrix}M ( \begin{matrix}{r}_{\_ in} \\ {g}_{\_ in} \\ {b}_{\_ in}\end{matrix} ) , in case of natural image region \\ M ( \begin{matrix}{p}_{\_ r} \cdot {r}_{\_ in} \\ {p}_{\_ g} \cdot {g}_{\_ in} \\ {p}_{\_ b} \cdot {b}_{\_ in}\end{matrix} ) , in case of external display device region\end{matrix} \qquad ( 2 )$$

M in the equation (2) represents the color editing parameters on the basis of CDL, LUT, or the like prepared by the user. M is applied to both the natural image region and the external display device region in order to change the appearance of the entire screen. On the other hand, the color adjustment parameters (p_r, p_g, p_b) are applied only to the area of the external display device.

The order of the color adjustment and the color editing is that the color adjustment is performed first, and thereafter the color editing is performed. For example, it is assumed that the color editing is the color conversion expressed as “(r_out, g_out, b_out)=(0.9×r_in, g_in, b_in)” and the color adjustment parameters are (1.0, 1.0, 0.9).

The total color conversion applied to the external display device region is expressed as “(r_out, g_out, b_out)=(0.9×r_in, g_in, 0.9×b_in).”

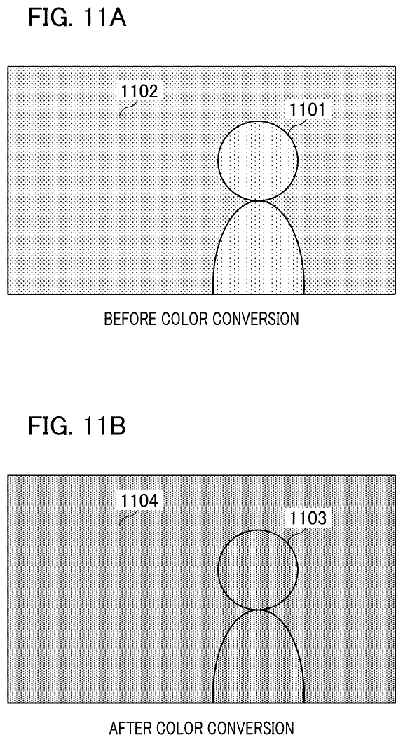

FIGS. 11A and 11B are schematic diagrams for illustrating examples of an input to the color conversion unit 105 and an output corresponding thereto. FIG. 11A shows an image before the color conversion and shows a natural image region 1101 corresponding to a person and an external display device region 1102 corresponding to a background.

It is expressed that a deviation in white balance between the natural image region 1101 and the external display device region 1102 has occurred and the entire image is before the color editing.

FIG. 11B shows an image after the color conversion. In the image after the color adjustment and the color editing, a natural image region 1103 corresponding to a person and an external display device region 1104 corresponding to a background are shown. The color conversion is applied to the natural image region 1103 on the basis of the color editing parameters prepared by the user.

The color conversion is applied to the external display device region 1104 on the basis of the color adjustment parameters for the color matching between the external display device region and the natural image region generated by the display control device and the color editing parameters prepared by the user.

For example, the pixel values of the natural image region 1101 shown in FIG. 11A are set to (255, 255, 255), and the pixel values of the external display device region 1102 are set to (230, 230, 255). In this case, “(r_out, g_out, b_out)=(0.9×r_in, g_in, b_in),” which corresponds to conversion of the color editing, is applied to the region 1101.

In addition, “(r_out, g_out, b_out)-(0.9×r_in, g_in, 0.9×b_in),” which corresponds to the total color conversion of the color adjustment and the color editing, is applied to the region 1102. As shown in FIG. 11B, the pixel values of the region 1103 after the color conversion are (230, 255, 255), and the pixel values of the region 1104 are (207, 230, 230).

In this case, if the pixel values of the regions 1103 and 1104 are normalized by dividing them by the maximum pixel values of each region, the pixel values of both regions become (0.9, 1.0, 1.0). It can be seen that the white balance of the region 1103 comes closer to that of the region 1104 and the appearance of the entire screen has been changed by applying the color conversion using the color editing parameters prepared by the user.

In the present embodiment, the color editing is applied to the natural image region using predetermined color editing parameters. The color editing and the color adjustment are applied to the external display device region by the color conversion using the predetermined color editing parameters and the color adjustment parameters generated by the display control device.

The predetermined color editing parameters are, for example, color editing parameters prepared by the user and specified by the operation unit. Alternatively, the predetermined color editing parameters are color editing parameters specified by the user using the operation unit among a plurality of color editing parameters stored in advance in the display control device.

According to the present embodiment, it is possible to perform adjustment of an overall appearance of a displayed image while inhibiting the influence on an image caused by a difference in color due to a difference in spectral characteristics between the external display device region and the natural image region.

### Fourth Embodiment

Next, a fourth embodiment will be described. A display control device of the present embodiment outputs the color conversion parameters to be applied to the natural image region and the external display device region as a color conversion file.

In the color conversion file, information about an imaging device to be applied, an application frame, and an application region is added as metadata information. The following shows an example of outputting CDL data as the color conversion file. In the present embodiment, “color conversion processing” indicates any one process of “color editing,” “color adjustment,” and “color adjustment and color editing.”

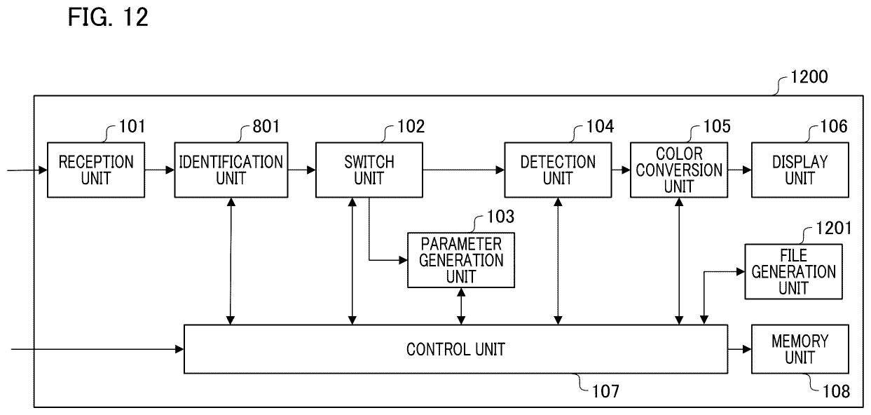

FIG. 12 is a block diagram showing a configuration example of a display device according to the present embodiment. In a display device 1200, a file generation unit 1201 is added to the configuration of the display device 800 shown in FIG. 8.

The file generation unit 1201 calculates different color conversion parameters for the external display device region and the natural image region on the basis of the color editing parameters specified by the user and the color adjustment parameters generated by the parameter generation unit 103.

The file generation unit 1201 generates a color conversion file in accordance with an instruction of the control unit 107. Not only the color conversion parameters but also the region information is assigned in the color conversion file generated by the file generation unit 1201.

Further, the file generation unit 1201 receives identification information and time code of the imaging device acquired from metadata of signals at a timing at which the color conversion unit 105 starts color conversion from the detection unit 104 via the control unit 107. The file generation unit 1201 assigns the acquired identification information (camera identifier) and time code of the imaging device to the color conversion file as metadata.

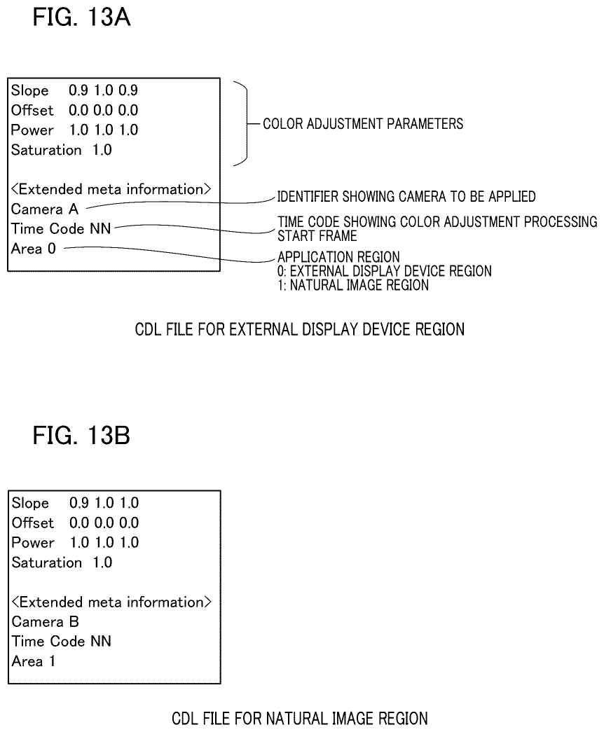

FIGS. 13A and 13B are diagrams illustrating examples of files generated by the file generation unit 1201. FIG. 13A shows a file for the external display device region, and FIG. 13B shows a file for the natural image region.

Slope, Offset, and Power are parameters that are applied individually to each RGB color. Slope is used to adjust a white level of an image, Offset is used to adjust a black level of an image, and Power is used to adjust a gamma of an image.

For example, in the case of “(r_out, g_out, b_out)=(0.9×r_in, g_in, 0.9×b_in),” which corresponds to the color conversion, Slope=(0.9, 1.0, 0.9) is satisfied. In addition, Saturation is a parameter that is equally applied to RGB and is used to adjust a saturation of an image.

The following information is described as extended meta information, for example.
Camera identifier: Information indicating to which camera the color conversion file is applied.
Time code: Information indicating to which frame the color conversion file is applied.
Region information: Information indicating whether the color conversion file is applied to the external display device region or the natural image region.

For example, if a setting value of the region information is zero, the region to which the color conversion file is applied is the external display device region. If the setting value of the region information is 1, the region to which the color conversion file is applied is the natural image region.

The color conversion file generated by the file generation unit 1201 is output to an external device. For example, a case in which a video processing device serving as the external device uses the color conversion file will be described. The time code and the region information are acquired from video signals input from the display device 1200 to the video processing device.

The video processing device determines whether or not it is the color conversion file in which the acquired time code and region information are described. If the video processing device determines that it is the color conversion file, the color conversion is applied to the region corresponding to the information described in the color conversion file.

The display control device of the present embodiment outputs the color conversion parameters to be applied to the natural image region and the external display device region as the color conversion file. Identification information of an imaging device to be applied, information of an application frame, and information of an application region are assigned in the color conversion file as metadata.

The color conversion content performed for each region serving as processing targets can be recorded as numerical values, and thus, in a subsequent filming process, editing process, or the like, color adjustments made on-site can be easily reproduced on the basis of the recorded data of the color conversion file.

In the present embodiment, a CDL file has been described as an example of the color conversion file, but the file generated by the file generation unit 1201 may be a 1D-LUT file or a 3D-LUT file.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to the embodiments, a computer program realizing the function of the embodiments described above may be supplied to the display control device or the like through a network or various storage media. Then, a computer (or a CPU, an MPU, or the like) of the display control device or the like may be configured to read and execute the program. In such a case, the program and the storage medium storing the program configure the present invention.

In addition, the present invention includes those realized using at least one processor or circuit configured to perform functions of the embodiments explained above. For example, a plurality of processors may be used for distribution processing to perform functions of the embodiments explained above.

This application claims the benefit of priority from Japanese Patent Application No. 2024-006153, filed on Jan. 18, 2024, which is hereby incorporated by reference herein in its entirety.

What is claimed is:

1. A display control device comprising at least one processor or circuit configured to function as:
an acquisition unit configured to acquire image data having a first region corresponding to a region in which an external display device displays an image and a second region corresponding to a subject different from the external display device;
a detection unit configured to perform detection of the first region from the image data;
a generation unit configured to generate a first parameter for performing color matching between the first region and the second region; and
a color conversion unit configured to perform color adjustment of an image using the first parameter,
wherein the color conversion unit performs the color adjustment on the first region detected by the detection unit using the first parameter.

2. The display control device according to claim 1, wherein the detection unit detects a region corresponding to a distance to the external display device as the first region from information acquired by a ranging unit configured to measure the distance to the external display device, and detects a region having a different distance from the region as the second region.

3. The display control device according to claim 2, wherein a distance from the ranging unit to the subject is smaller than a distance from the ranging unit to the external display device.

4. The display control device according to claim 1, wherein the generation unit generates the first parameter configured to reduce a difference between a pixel value of the image displayed on the external display device and a pixel value of the image captured by an imaging device.

5. The display control device according to claim 1, wherein the at least one processor or circuit is further configured to function as an identification unit configured to acquire identification information of an imaging device,
wherein the generation unit generates the first parameter by associating the first parameter with the identification information, and
the color conversion unit performs the color adjustment using the first parameter associated with the identification information.

6. The display control device according to claim 1, wherein the color conversion unit performs color editing for the entire screen using a specified second parameter.

7. The display control device according to claim 6, wherein the color conversion unit performs the color adjustment using the first parameter and the color editing using the second parameter for the first region, and performs the color editing using the second parameter for the second region.

8. The display control device according to claim 1, wherein the at least one processor or circuit is further configured to function as a file generation unit configured to generate a file having the first parameter,
wherein the file generation unit assigns to the first parameter one or more pieces of information among identification information of an imaging device in which color conversion is applied to an image, information indicating a frame of the image to which the color conversion is applied, and information indicating an image region to which the color conversion is applied.

9. The display control device according to claim 1, wherein the generation unit generates the first parameter from pixel values, a brightness, or a chromaticity of an image obtained by capturing a plurality of image regions displayed on the external display device.

10. An image processing system comprising at least one processor or circuit configured to function as:
an acquisition unit configured to acquire image data having a first region corresponding to a region in which an external display device displays an image and a second region corresponding to a subject different from the external display device;
a detection unit configured to perform detection of the first region from the image data;
a generation unit configured to generate a first parameter for performing color matching between the first region and the second region;
a color conversion unit configured to perform color adjustment of an image using the first parameter;
an imaging unit configured to capture images relating to the first and second regions and output the image data to a display control device; and
a display unit configured to display the image on which the color adjustment has been performed,
wherein the color conversion unit performs the color adjustment on the first region detected by the detection unit using the first parameter.

11. A display control method executed by a display control device configured to perform display control of an image, comprising:
acquiring image data having a first region corresponding to a region in which an external display device displays an image and a second region corresponding to a subject different from the external display device;
performing detection of the first region from the image data;
generating a parameter for performing color matching between the first region and the second region; and
performing color adjustment of an image using the generated parameter and performing the color adjustment on the first region using the parameter.

12. A non-transitory computer-readable storage medium configured to store a computer program comprising instructions for executing the following processes:
acquiring image data having a first region corresponding to a region in which an external display device displays an image and a second region corresponding to a subject different from the external display device;
performing detection of the first region from the image data;
generating a parameter for performing color matching between the first region and the second region; and
performing color adjustment of an image using the generated parameter and performing the color adjustment on the first region using the parameter.
